(19) United States
(12) Patent Application Publication
(10) Pub. No.: US 2009/0113154 A1
(43) Pub. Date: Apr. 30, 2009

(54) Non-Volatile Memory Apparatus and Method of Accessing the Same

(75) Inventors: Su-Fen Guan, Hsinchu Hsien (TW); Chun-Kun Lee, Chupei City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SILICON MOTION, INC., Jhubei City (TW)

(21) Appl. No.: 12/114,157

(22) Filed: May 2, 2008

(30) Foreign Application Priority Data
Oct. 26, 2007 (TW) 096140222

(51) Int. Cl. G06F 12/00

(52) U.S. Cl. 711/163; 711/E12.001

(57) ABSTRACT

A non-volatile memory apparatus and an accessing method thereof are provided. A host accesses the non-volatile memory apparatus and gets the accessing result according to the predetermined protocol. Therefore, the host can identify whether the non-volatile memory apparatus has a data area or not and switch to access the data area. The host can then access the non-volatile memory apparatus with high capacity without changing the hardware of the host.

This application claims the benefit of priority based on Taiwan Patent Application No. 096140222, filed on Oct. 26, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a non-volatile memory apparatus and an accessing method thereof. In particular, the present invention relates to a non-volatile memory apparatus capable of utilizing a predetermined protocol to change the accessing area and the accessing method thereof.

2. Descriptions of the Related Art

The development of hardware technologies has resulted in the increased capacity of non-volatile memory apparatuses. For instance, a high-capacity secure digital (SD) memory card has already been made with a memory capacity of more than 4 gigabytes (GB). Unfortunately, according to the current protocols, different access interfaces are adopted for a high-capacity memory card and a low-capacity memory card respectively. For example, the access interface adopted for a high-capacity SD memory card is known as the SD 2.0, while that adopted for a low-capacity SD memory card is known as the SD 1.1. Consequently, the host (e.g., a computer, a digital camera, a card reader or the like) adapted to access a low-capacity memory card will fail to access a high-capacity memory card in the same accessing mode. Therefore, a user possessing a host adapted to access a low-capacity memory card would be unable to access a high-capacity memory card if he does not change or upgrade the host, leading to inefficient use of hardware resources and inconvenience.

Accordingly, it is highly desirable in the art to provide a solution allowing a host originally configured to read a low-capacity memory card to also read a high-capacity one without making any changes to the microprocessor of the host. Such a solution will even eliminate the concerns regarding the sustained replacement of the hosts to cater for future ultrahigh-capacity memory cards.

### SUMMARY OF THE INVENTION

One objective of this invention is to provide a non-volatile memory apparatus and an accessing method thereof. By accessing the non-volatile memory apparatus according to a predetermined protocol and obtaining a reply with respect to an accessing result, the host can identify the data area of the non-volatile memory apparatus and then switch to access the data area. In this way, the host can access a high-capacity non-volatile memory apparatus without changing the hardware of the host.

The non-volatile memory apparatus comprises a protective area separated from the data area. The host is adapted to access the protective area according to a predetermined protocol. The predetermined protocol may include one of the following components: comprising a particular command generated according to a plurality of standard read/write commands, accessing a particular region of the protective area, and accessing particular information stored in the protective area.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates the connections between a non-volatile memory apparatus of this invention and a host;

FIG. 2 is a schematic view of a particular command complying with a predetermined protocol;

FIG. 3a depicts an embodiment of a write command;

FIG. 3b depicts an embodiment of a reply byte; and

FIG. 4 is a flow diagram illustrating the access of a non-volatile memory apparatus in accordance with this invention.

### DESCRIPTION OF THE PREFERRED EMBODIMENT

The embodiments will be described hereinbelow to explain this invention. This invention relates to a non-volatile memory status with at least two areas and a method for accessing the non-volatile memory apparatus. However, these embodiments are not intended to limit this invention to any specific context, applications or with particular methods described in these embodiments. Therefore, the description of these embodiments is only intended to illustrate rather than to limit this invention. It should be noted that in the following embodiments and attached drawings, elements unrelated to this invention are omitted from depiction, and dimensional relationships among individual elements are exaggerated for purpose of clarity.

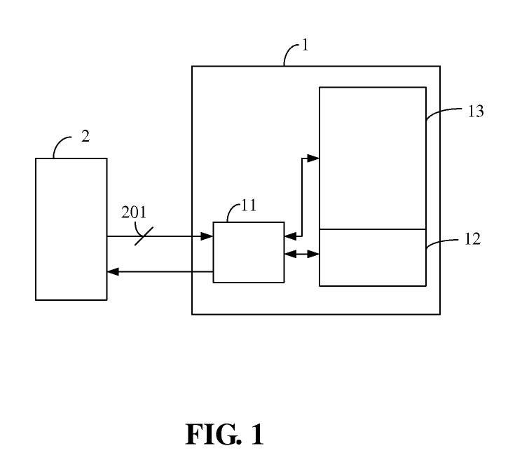

FIG. 1 illustrates the connections between a non-volatile memory apparatus 1 and a host 2. The non-volatile memory apparatus 1 receives a command from the host 2 to perform an access operation. The non-volatile memory apparatus 1 includes a control module 11, a protective area 12 and a data area 13. The control module 11 is adapted to receive a control signal 201 from the host 2 to access the protective area 12, and according to the accessing result of accessing the protective area 12, will determine if the data area 13 can be accessed. In this embodiment, once the control module 11 switches from accessing the protective area 12 to accessing the data area 13 according to the accessing result, the control module 11 will not be allowed to access the protective area 12 again. That is, the control module 11 is allowed to access only either the protective area 12 or the data area 13 at any given time.

The control module 11 is configured to access the protective area 12 and the data area 13 in different modes. In this embodiment, the control module 11 accesses the protective area 12 in the logical block address (LBA) mode and the data area 13 in a sector mode. The data area 13 has a storage capacity greater than 2 GB.

Since the protective area 12 and the data area 13 are accessed using different modes, the control module 11 initially receives a command from the host 2 to access the protective area 12. For the control module 11 to access the data area 13, the host 2 enables the control module 11 to access the protective area 12 according to the predetermined protocol, and then according to the accessing result of the protective area 12, switches the access operation from the protective area 12 to the data area 13.

In other words, by means of the predetermined protocol, the host 2 can identify whether the non-volatile memory apparatus 1 has a data area 13, and then accesses the data area 13 using the access mode appropriate for the data area 13.

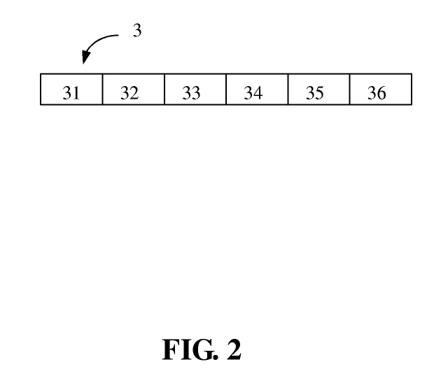

In this embodiment, the predetermined protocol comprises a particular command generated according to a plurality of standard read/write commands. As shown in FIG. 2, a particular command 3 complying with the predetermined protocol is depicted therein. The particular command 3 is adapted for the control operations between the host 2 and the non-volatile memory apparatus 1. The particular command 3 consists of a plurality of standard read/write commands in a predetermined sequence, including a read command 31, a read command 32, a read command 33, a read command 34, a write command 35 and a read command 36. Once the host 2 transmits the particular command 3 to the non-volatile memory apparatus 1, the non-volatile memory apparatus 1 executes an access operation according to the particular command 3 and transmits the accessing result back to the host 2 to enable the host 2 to access the data area 13 of the non-volatile memory apparatus 1. In other words, the host 2 changes the access mode to access the data area 13. It should be noted that in other embodiments, the particular command 3 may also be formed in other ways. For example, the particular command may be formed by combining the common commands in a specific sequence. The commands are not just limited to the read commands, but may also be a Read ID command, a Reset command, a Page Program command, a Block Erase command, a Read Status command, or a combination thereof. Alternatively, the particular command 3 may also be defined by the manufacturers themselves and consist of a command set in a predetermined sequence.

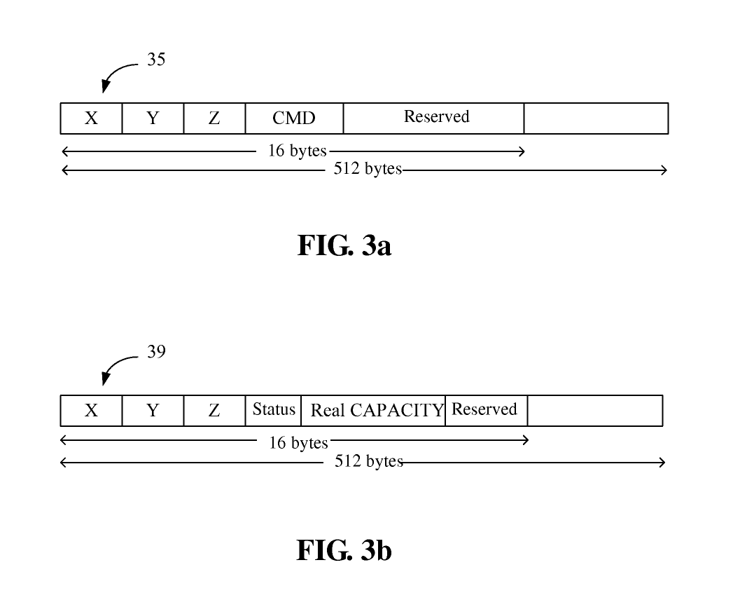

The read command 31 represents a command to read the data of LBA A, the read command 32 represents a command to read the data of LBA B, and the read command 33 represents a command to read the data of LBA C. For example, when the read command 31 is transmitted by the host 2 to the non-volatile memory apparatus 1, the control module 11 reads the data of LBA A into a buffer area thereof first, and then the host 2 reads the data out of the buffer area. When receiving the read commands 31, 32, 33 and 34 in succession, the control module 11 of the non-volatile memory apparatus 1 reasonably anticipates that the host 2 is likely to transmit a particular command to retrieve the particular information, e.g., to read capacity information of the data area 13 of the non-volatile memory apparatus 1. Then the host 2 transmits the write command 35, which comprises a command complying with the predetermined protocol, e.g., a command to inquire capacity information of the data area 13 of the non-volatile memory apparatus 1. FIG. 3a illustrates an embodiment of the write command 35, where the command complying with the predetermined protocol lies at a position as indicated by CMD in FIG. 3a. The write command 35 further comprises at least one reserved position. The bit lengths of some portions of the write command 35 are indicated in this figure for ease of understanding. After the non-volatile memory apparatus 1 has received the write command 35 and the control module 11 has confirmed the first three information elements X, Y, Z, the control module 11 can ascertain that the next information is a command. Then the non-volatile memory apparatus 1 generates a reply byte 39 accordingly and puts it into the buffer area in the control module 11. The reply byte 39, an embodiment of which is depicted in FIG. 3b, comprises the information corresponding to the command of the predetermined protocol. For example, this embodiment comprises the capacity information of the data area 13, while the reply byte is put into the buffer area of the control module 11. In this embodiment, the reply byte 39 has a bit length of 512 bytes. Next, when the host 2 transmits the read command 36, the host 2 reads the reply byte 39 out of the buffer area of the control module 11, and derives the information corresponding to the command of the predetermined protocol from the reply byte 39, e.g., the capacity information of the data area 13 in this embodiment. The capacity information lies at a position indicated by the Real CAPACITY in FIG. 3b, while the reply byte 39 further comprises at least a status position and a reserved position. Similarly, the bit lengths of some portions of the reply byte 39 are indicated in this figure for ease of understanding. In another embodiment, the particular information may also be an authorization code of the non-volatile memory apparatus, an identity code of the non-volatile memory apparatus, or a combination thereof.

It should be noted that the embodiments depicted in FIGS. 3a and 3b are only provided to illustrate such a command, and for ease of understanding, relationships between the individual information elements of the command are exaggerated. Those skilled in the art may make modifications to the content of the command without departing from the objective of this invention. For example, in other embodiments, modifications may be made to the sequence of the contents, length, or information elements of the command.

In summary, upon receiving a plurality of standard read/write commands in a predetermined sequence, the control module 11 returns the accessing result complying with the predetermined protocol to the host 2 to inform the host 2 that the non-volatile memory apparatus 1 has a data area 13 and capacity of the data area 13. Upon receiving the accessing result, the host 2 switches to access the data area 13. In this embodiment, the host 2 switches to access the data area 13 in the sector mode once it receives the accessing result.

In another embodiment, the predetermined protocol includes the following steps: accessing a particular area or particular information in the protective area 12 of the non-volatile memory apparatus 1. Upon receiving the command to access the particular area or particular information in the protective area 12, the control module 11 returns an accessing result complying with the predetermined protocol to the host 2 to inform the host 2 that the non-volatile memory apparatus 1 has a data area 13. Upon receiving the accessing result, the host 2 switches to access the data area 13.

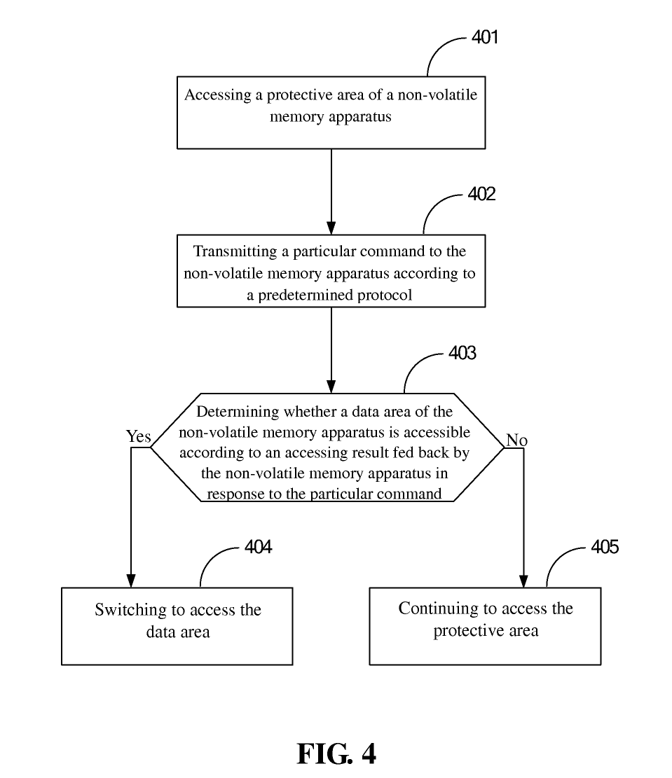

FIG. 4 illustrates a flow diagram of a process of accessing a non-volatile memory apparatus. The non-volatile memory apparatus may be one of those described in the above embodiments, and hereinbelow. The non-volatile memory apparatus 1 depicted in FIG. 1 will be used as an example. Initially in step 401, the protective area 12 of the non-volatile memory apparatus 1 is accessed. Then, in step 402, a particular command is transmitted to the non-volatile memory apparatus 1 according to a predetermined protocol, which may be one of the predetermined protocols described in the above embodiments. Next in step 403, the data area 13 of the non-volatile memory apparatus 1 is accessible according to the accessing result fed back by the non-volatile memory apparatus 1 in response to the particular command. If the accessing result indicates compliance with the predetermined protocol, the host switches to access the data area 13 of the non-volatile memory apparatus 1 to retrieve data contained therein, as shown in step 404. On the other hand, if the accessing result indicates a failure to comply with the predetermined protocol, the host continues to access the protective area 12 of the non-volatile memory apparatus 1, as shown in step 405.

It should be noted that step 402 may be accomplished by one of the following operations: executing a command or a combination of commands complying with the predetermined protocol, accessing particular information stored in the protective area 12, accessing a particular area of the protective area 12, and accessing particular information stored in a particular area of the protective area 12. As a result, if the non-volatile memory apparatus 1 has a data area 13, the host switches to access the data area 13.

The non-volatile memory apparatus of the above embodiments may be a memory card. This invention is unique in that it accesses the non-volatile memory apparatus according to a predetermined protocol and receives a reply after accessing the information so that the host can identify whether or not the non-volatile memory apparatus has a data area and then switches to access the data area. In this way, the host can access a high-capacity non-volatile memory apparatus without changing the hardware of the host. Therefore, both the host and control module of the non-volatile memory apparatus should be able to access and reply according to the predetermined protocol.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method of accessing a non-volatile memory apparatus, the non-volatile memory apparatus having a protective area and a data area, the method comprising the steps of:
accessing the protective area of the non-volatile memory apparatus according to a predetermined protocol; and
accessing the data area of the non-volatile memory apparatus according to an accessing result of accessing the protective area.

2. The method as claimed in claim 1, wherein the step of accessing the protective area is executed in a first mode, and the step of accessing the data area is executed in a second mode.

3. The method as claimed in claim 2, wherein the first mode is a logical block address (LBA) mode, and the second mode is a sector mode.

4. The method as claimed in claim 1, wherein the predetermined protocol comprises a particular command being generated according to a plurality of standard read/write commands.

5. The method as claimed in claim 4, wherein the standard read/write commands are provided with a predetermined sequence.

6. The method as claimed in claim 1, wherein the step of accessing the protective area is executed to access a particular area of the protective area of the non-volatile memory apparatus.

7. The method as claimed in claim 1, wherein the step of accessing the protective area is executed to access particular information stored in the protective area of the non-volatile memory apparatus.

8. The method as claimed in claim 7, wherein the particular information is selected from the group consisting of a quantity of the data area, an authority code of the non-volatile memory apparatus, an identity code of the non-volatile memory apparatus, and a combination thereof.

9. The method as claimed in claim 1, wherein the predetermined protocol comprises a particular command, the particular command is selected from the group consisting of a Read ID command, a Reset command, a Page Program command, a Block Erase command, a Read Status command, and a combination thereof.

10. A non-volatile memory apparatus, comprising:
a protective area;
a data area; and
a control module, being adapted to receive a control signal to access the protective area, and to access the data area according to an accessing result of accessing the protective area.

11. The non-volatile memory apparatus as claimed in claim 10, wherein the control module is configured to access the protective area and the data area in different modes.

12. The non-volatile memory apparatus as claimed in claim 10, wherein the control module is configured to access the protective area in a logical block address (LBA) mode, and to access the data area in a sector mode.

13. The non-volatile memory apparatus as claimed in claim 10, wherein the control signal is generated according to a plurality of standard read/write commands.

14. The non-volatile memory apparatus as claimed in claim 13, wherein the standard read/write commands are provided with a predetermined sequence.

15. The non-volatile memory apparatus as claimed in claim 13, wherein the control signal is selected from the group consisting of a Read ID command, a Reset command, a Page Program command, a Block Erase command, a Read Status command, and a combination thereof.

16. The non-volatile memory apparatus as claimed in claim 10, wherein the control module is configured to receive the control signal for accessing a particular area of the protective area.

17. The non-volatile memory apparatus as claimed in claim 10, wherein the control module is configured to receive the control signal for accessing particular information stored in the protective area.

18. The non-volatile memory apparatus as claimed in claim 17, wherein the particular information is selected form the group consisting of a quantity of the data area, an authority code of the non-volatile memory apparatus, an identity code of the non-volatile memory apparatus, and a combination thereof.

19. The non-volatile memory apparatus as claimed in claim 10, wherein the control signal comprises a particular command comprising at least one information element, and the control module ascertains a next information following up the at least one information element according to the at least one information el and accesses the data area.

20. The non-volatile memory apparatus as claimed in claim 19, wherein the control module retrieves a reply comprising information comprising at least one information element identical to the at least one information element of the particular command.
